(19) United States
(12) Patent Application Publication
(10) Pub. No.: US 2011/0216759 A1
(43) Pub. Date: Sep. 8, 2011

(54) METHOD FOR PUBLISHING, QUERYING AND SUBSCRIBING TO INFORMATION BY A SIP TERMINAL IN A VoIP NETWORK SYSTEM, SIP TERMINAL, SIP APPLICATION SERVER, SIP INFORMATION CENTER AND VoIP NETWORK SYSTEM

(76) Inventors: Xiangyun Qian, Shanghai (CN); Aihao Yin, Shanghai (CN); Xiao Wang, Shanghai (CN); Peng Liu, Shanghai (CN)

(21) Appl. No.: 12/671,560

(22) PCT Filed: Aug. 2, 2007
(86) PCT No.: PCT/CN07/02329

§ 371 Date: Feb. 1, 2010

(51) Int. Cl. H04L 12/66

(52) U.S. Cl. 370/352

(57) ABSTRACT

The invention provides method for publishing, querying, subscribing to information by a SIP terminal in a VoIP network system, a SIP terminal, a SIP application server, a SIP information center and the VoIP network system. Wherein the VoIP network system is deployed with SIP information center for storing and providing at least the information. The method for publishing information by a SIP terminal in a VoIP network system comprises: creating a publishing request with the information to be published embedded in at the SIP terminal; sending the publishing request from the SIP terminal to the SIP information center via the SIP application server; recording the information in the SIP information center's database; and notifying the new information update to the subscribed SIP terminals.

### TECHNICAL FIELD OF THE INVENTION

The present invention relates to communication technology, in particular, to methods respectively for publishing, querying and subscribing to information by a SIP terminal in a VoIP network system, a SIP terminal, a SIP application server, a SIP information center and the VoIP network system

### BACKGROUND OF THE INVENTION

More and more service providers deploy the next generation network, i.e. VoIP network, to support their customers with SIP (Session Initiation Protocol) enabled phone. Those customers use their SIP phones to communicate with each other in voice or video over IP networks.

However, unlike the IP network, there is no mechanism in the VoIP network system at present for the SIP customers to publish, query or subscribe to information by using their SIP phones besides communicating with others.

A SIP phone includes software terminal and hardware telephone set. Comparing to traditional PSTN phone, SIP phone is much more intelligent. This enables the development of new and fancy SIP information services by service providers besides the VoIP services.

### SUMMARY OF THE INVENTION

The present invention is proposed to resolve the above problem in the prior art, the object of which is to provide methods respectively for publishing, querying and subscribing to information by a SIP terminal in a VoIP network system, a SIP terminal, a SIP application server, a SIP information center and the VoIP network system, in order to enable SIP users use their SIP phones to publish/query/subscribe to the interested topic/information to/from SIP information center provided by service provider.

According to one aspect of the invention, there is provided a method for publishing information by a SIP terminal in a VoIP network system, wherein the VoIP network system is deployed with SIP information center for storing and providing at least the information; said method comprises: creating a publishing request with the information to be published embedded in at the SIP terminal; sending the publishing request from the SIP terminal to the SIP information center via the SIP application server; and recording the information in the SIP information center's database.

According to another aspect of the invention, there is provided a method for querying information by a SIP terminal in a VoIP network system, wherein the VoIP network system is deployed with a SIP information center for storing and providing at least the information; said method comprises: creating a querying request with query conditions embedded in at the SIP terminal; sending the querying request from the SIP terminal to the SIP information center via the SIP application server; querying the information according to the querying request at the SIP information center; and returning query results from the SIP information center to the SIP terminal via the SIP application server.

According to another aspect of the invention, there is provided a method for subscribing to information by a SIP terminal in a VoIP network system, wherein the VoIP network system is deployed with a SIP information center for storing and providing at least the information; said method comprises: creating a subscribing request with subscribing conditions for subscribing to user-interested topic embedded in at the SIP terminal; sending the subscribing request from the SIP terminal to the SIP application server; monitoring whether there is new information published in the SIP information center which meets the subscribing conditions; and when there is new information of this topic published in the SIP information center, notifying it from the SIP information center to the SIP terminal via the SIP application server.

According to another aspect of the invention, there is provided a SIP terminal, comprising at least one of the following: an information publishing unit configured to create a publishing request with information to be published embedded in; an information querying unit configured to create a querying request with query conditions embedded in; and an information subscribing unit configured to create a subscribing request with subscribing conditions for subscribing to user-interested topic embedded in.

According to another aspect of the invention, there is provided a SIP application server, comprising at least one of the following: a publishing request processing unit configured to obtain information to be published from a publishing request received from a SIP terminal and forward it to SIP information center interacting with the SIP application server; a querying request processing unit configured to obtain query conditions from a querying request received from a SIP terminal and forward them to the SIP information center; and a subscribing request processing unit configured to monitor the update of the SIP information center and notify the new information in the SIP information center, which is subscribed by a subscribing request received from a SIP terminal, to the SIP terminal.

According to another aspect of the invention, there is provided a SIP information center, comprising: at least one database for storing information; a database updating unit configured to update the at least one database based on information to be published which is received from a SIP terminal via a SIP application server; and a querying unit configured to query the at least one database for the information meeting query conditions received from a SIP terminal via a SIP application server.

According to another aspect of the invention, there is provided a SIP network system, comprising: at least one SIP terminal as described above; at least one SIP application server as described above; and at least one SIP information center as described above.

### BRIEF DESCRIPTION OF THE DRAWINGS

It is believed that the features, advantages and purposes of the present invention will be better understood from the following description of the detailed implementation of the present invention read in conjunction with the accompanying drawings, in which:

FIG. 1 depicts a schematic block diagram of the VoIP network system according to an embodiment of the invention, in which the methods respectively for publishing, querying and subscribing to information by a SIP terminal in the VoIP network system according to embodiments of the invention can be implemented;

FIG. 2 depicts a flowchart of the method for publishing information by a SIP terminal in the VoIP network system according to an embodiment of the invention;

FIG. 3 (a) depicts an exemplary publish pattern in BUY/SELL model;

FIG. 3 (b) depicts a detailed publishing request extended from SIP REGISTER message according to an embodiment of the invention;

FIG. 4 depicts a flowchart of the method for querying information by a SIP terminal in the VoIP network system according to an embodiment of the invention;

FIG. 5 (a) an exemplary query pattern in BUY/SELL model;

FIG. 5 (b) depicts a detailed querying request extended from SIP REGISTER message according to an embodiment of the invention;

FIG. 6 depicts a detailed querying response message extended from SIP 200 OK response message according to an embodiment of the invention;

FIG. 7 depicts a flowchart of the method for subscribing to information by a SIP terminal in the VoIP network system according to an embodiment of the invention;

FIG. 8 depicts a schematic block diagram of the SIP terminal in the VoIP network system of FIG. 1 according to an embodiment of the invention;

FIG. 9(a) depicts an exemplary information publishing UI on the SIP terminal of FIG. 8 according to an embodiment of the invention;

FIG. 9(b) depicts an exemplary information querying UI on the SIP terminal of FIG. 8 according to an embodiment of the invention;

FIG. 9(c) depicts an exemplary information subscribing UI on the SIP terminal of FIG. 8 according to an embodiment of the invention;

FIG. 10 depicts a schematic block diagram of the SIP application server in the VoIP network system of FIG. 1 according to an embodiment of the invention; and

FIG. 11 depicts a schematic block diagram of the SIP information center in the VoIP network system of FIG. 1 according to an embodiment of the invention.

### DETAILED DESCRIPTION OF EMBODIMENTS OF THE INVENTION

Next, a detailed description of preferred embodiments of the present invention will be given with reference to the drawings.

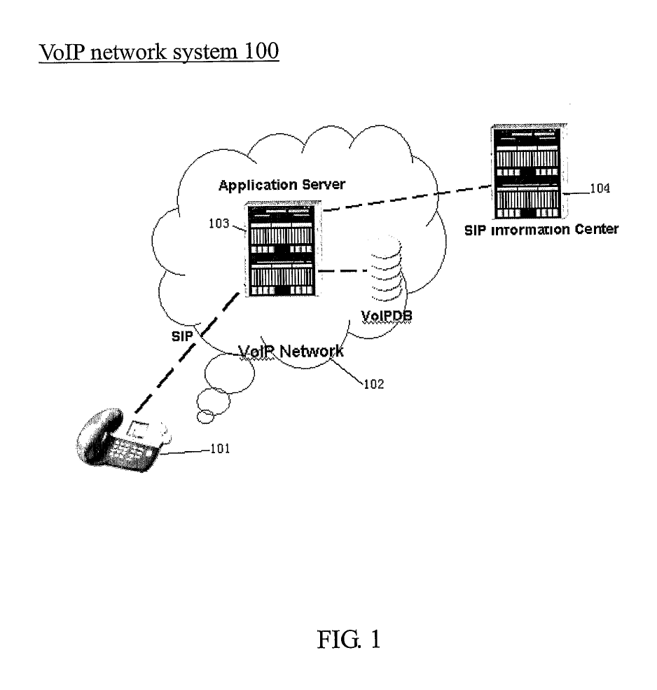

FIG. 1 depicts a schematic block diagram of the VoIP network system according to an embodiment of the invention, in which the methods respectively for publishing, querying and subscribing to information by a SIP terminal in the VoIP network system according to embodiments of the invention can be implemented.

As shown in FIG. 1, SIP terminal 101 is connected to VoIP network 102 via SIP channel.

The SIP application server 103 in the VoIP network 102 is designed for the development and delivery of communications services. The SIP application server is both a platform and an application-creation environment that enables service providers to develop and provide their next-generation services. The services will enhance service providers' infrastructure deployments, as well as their revenue.

If the user of the SIP terminal 101 wishes to subscribe to a service provided by the SIP application server 103, then he/she firstly needs to register to the SIP application server 103 to receive a username and password and instructions on how to access the server.

In addition, as shown in FIG. 1, the VoIP network system 100 is deployed with SIP information center 104 provided by service provider, for storing and providing information. The SIP information center 104 is connected to the VoIP network 102 and can interact with the SIP application server 103.

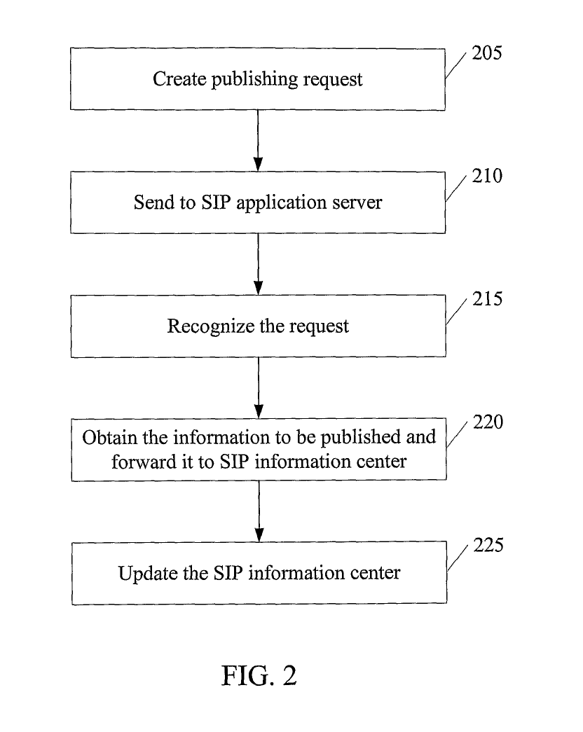

On the basis of the architecture of the VoIP network system of FIG. 1, the present invention provides a method for publishing information by a SIP terminal in the VoIP network system. FIG. 2 depicts a flowchart of the method for publishing information by a SIP terminal in the VoIP network system according to an embodiment of the invention.

As shown in FIG. 2, firstly, at step 205, a SIP terminal such as the SIP terminal 101 creates a publishing request with the information to be published embedded in.

In general, a SIP terminal, also called SIP User Agent (UA) maintains its active registration to the VoIP network by periodically sending SIP REGISTER message to the registrar functionality that exists on the SIP application server 103.

In the present embodiment, the SIP REGISTER message is used to allow the SIP terminal to publish information to the SIP information center 104. That is, the present embodiment extends the SIP REGISTER message as publishing request to publish information.

Specifically, in the present embodiment, a new content type such as “application/publish+xml” is defined for publishing user information to the SIP information center 104 and is added to be embedded in the body of the SIP REGISTER message. That is, the present embodiment extends the SIP REGISTER message as publishing request by setting the content type field therein as “application/publish+xml” to indicate that this is a publishing request and embedding the information to be published in the part <publish> of the body of the message.

In addition, the patterns in which the information to be published is embedded are pre-defined in profiles. The profiles are defined based on different services by service providers.

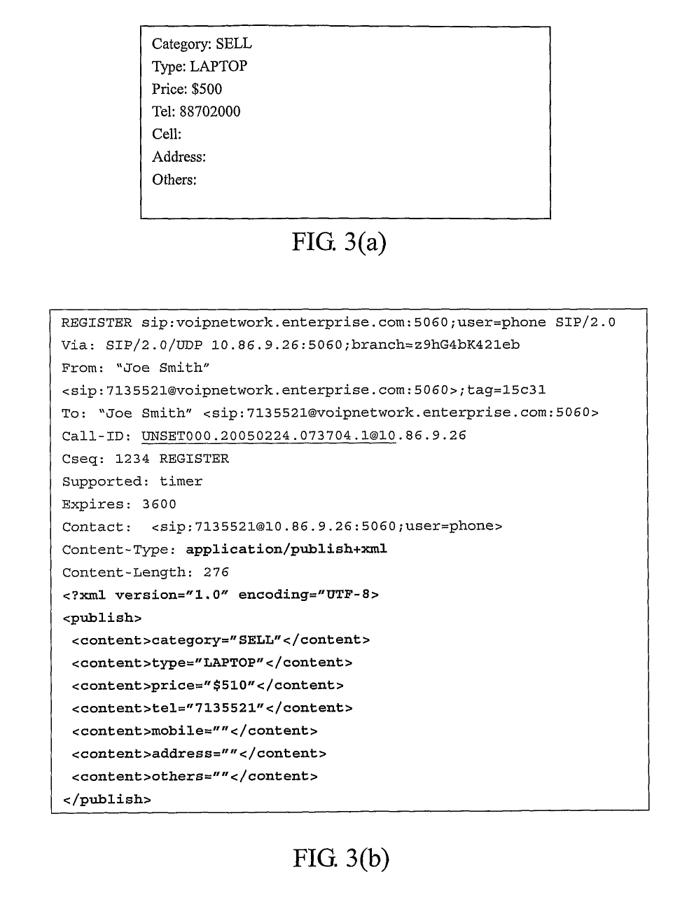

FIG. 3 (a) depicts an exemplary publish pattern in BUY/SELL model. FIG. 3 (b) depicts the detailed publishing request extended from SIP REGISTER message based on the publish pattern of FIG. 3 (a).

Accordingly, in the case of the publishing request like that of FIG. 3 (b), the process of creating a publishing request at step 205 is as follow: first, the SIP terminal creates a SIP REGISTER message; then the SIP terminal sets the content type field therein as “application/publish+xml” to indicate the SIP REGISTER message is a publishing request; and then the SIP terminal embeds the information to be published in the body of the SIP REGISTER message.

Next, at step 210, the SIP terminal sends the publishing request extended from SIP REGISTER message to the SIP application server 103.

At step 215, the SIP application server 103 recognizes the SIP REGISTER message received from the SIP terminal as a publishing request. Specifically, the SIP application server 103 recognizes the SIP REGISTER message as a publishing request by recognizing the content type field in the SIP REGISTER message and determining its value is “application/publish+xml”.

At step 220, the SIP application server 103 obtains the information to be published from the part <publish> of the body of the publishing request and forwards it to the SIP information center 104, indicating that it is the information to be published by the SIP terminal.

At step 225, the SIP information center 104 updates its database to write the information to be published received from the SIP application server in it.

The above is a description of the method for publishing information by a SIP terminal in the VoIP network system according to an embodiment of the invention. It can be seen from the above description that with the method according to the embodiment, the SIP customers can easily publish specific useful information to the SIP information center provided by service provider via SIP phones.

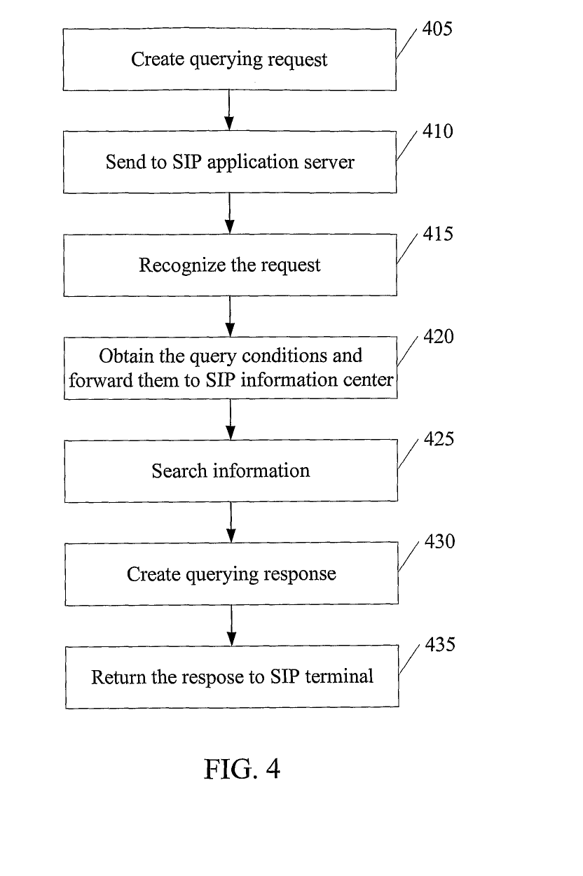

In addition, on the basis of the architecture of the VoIP network system of FIG. 1, the present invention also provides a method for querying information by a SIP terminal in the VoIP network system. FIG. 4 depicts a flowchart of the method for querying information by a SIP terminal in the VoIP network system according to an embodiment of the invention.

As shown in FIG. 4, firstly, at step 405, a SIP terminal such as the SIP terminal 101 creates a querying request with the query conditions embedded in.

In the present embodiment, the SIP REGISTER method is also used to allow the SIP terminal to query information from the SIP information center 104. That is, the present embodiment also extends the SIP REGISTER message as querying request to query information.

Specifically, in the present embodiment, a new content type such as “application/query+xml” is defined for querying specific information from the SIP information center 104 and is added to be embedded in the body of the SIP REGISTER message. That is, the present embodiment extends the SIP REGISTER message as querying request by setting the content type field therein as “application/query+xml” to indicate that this is a querying request and embedding the query conditions in the part <query> of the body of the message.

In addition, the patterns in which the query conditions is embedded are pre-defined in profiles. The profiles are defined based on different services by service providers.

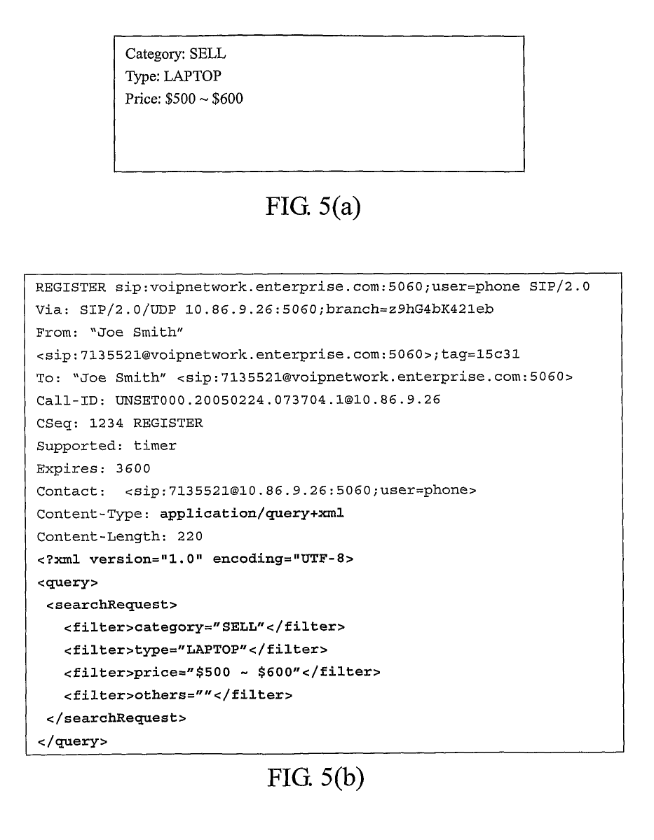

FIG. 5 (a) depicts an exemplary query pattern in BUY/SELL model. FIG. 5 (b) depicts the detailed querying request extended from SIP REGISTER message based on the query pattern of FIG. 5 (a).

Accordingly, in the case of the querying request like that of FIG. 5 (b), the process of creating a querying request at step 405 is as follow: first, the SIP terminal creates a SIP REGISTER message; then the SIP terminal sets the content type field therein as “application/query+xml” to indicate the SIP REGISTER message is a querying request; and then the SIP terminal embeds the query conditions in the part <query> of the body of the SIP REGISTER message.

Next, at step 410, the SIP terminal sends the querying request extended from SIP REGISTER message to the SIP application server 103.

At step 415, the SIP application server 103 recognizes the SIP REGISTER message received from the SIP terminal as a querying request. Specifically, the SIP application server 103 recognizes the SIP REGISTER message as a querying request by recognizing the content type field in the SIP REGISTER message and determining its value is “application/query+xml”.

At step 420, the SIP application server 103 obtains the query conditions from the part <query> of the body of the querying request and forwards them to the SIP information center 104, indicating that they are query conditions received from the SIP terminal.

At step 425, the SIP information center 104 searches information meeting the query conditions from its database and returns the query results to the SIP application server 103.

At step 430, the SIP application server 103 gets the query results from the SIP information center 104 and creates a querying response message with the query results embedded in.

In the present embodiment, the SIP 200 OK response message is used to allow the SIP application server 103 to return query results from the SIP information center 104 to the SIP terminal.

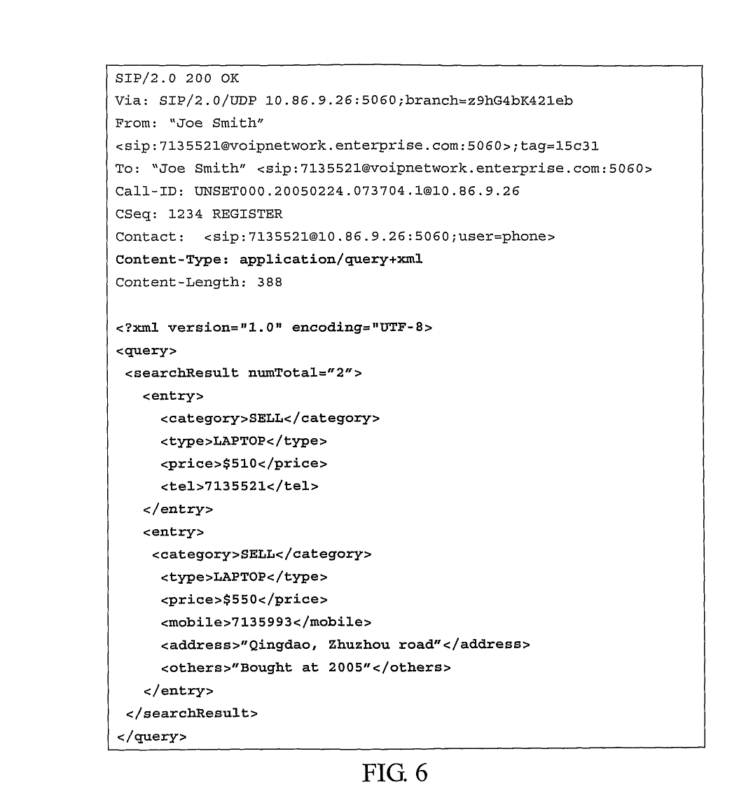

Specifically, in the present embodiment, a new content type such as “application/query+xml” is defined for returning query results from the SIP application server 103 and is added to be embedded in the body of the SIP 200 OK response message. That is, the present embodiment extends the SIP 200 OK response message as querying response message by setting the content type field therein as “application/query+xml” to indicate that this is a querying response message and embedding the query results in the part <query> of the body of the message. Such a detailed querying response message extended from SIP 200 OK response message is shown in FIG. 6.

Accordingly, in the case of the querying response message like that of FIG. 6, the process of creating a querying response message at step 430 is as follow: first, the SIP application server 103 creates a SIP 200 OK response message; then the SIP application server 103 sets the content type field therein as “application/query+xml” to indicate the SIP 200 OK response message is a querying response message; and then the SIP application server 103 embeds the query results in the part <query> of the body of the SIP 200 OK response message.

Next, at step 435, the SIP application server 103 returns the querying response message to the SIP terminal.

The above is a description of the method for querying information by a SIP terminal in the VoIP network system according to an embodiment of the invention. It can be seen from the above description that with the method according to the embodiment, the SIP customers can easily query and get specific useful information from the SIP information center provided by service provider via SIP phones.

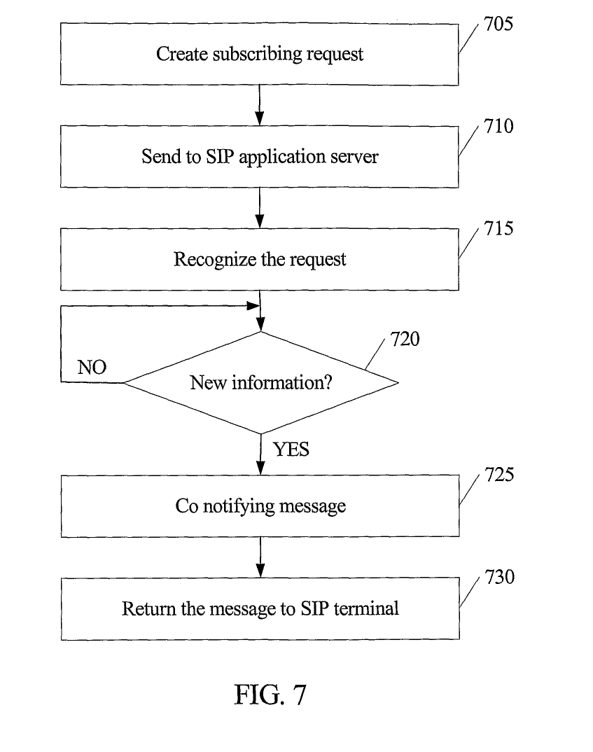

In addition, on the basis of the architecture of the VoIP network system of FIG. 1, the present invention also provides a method for subscribing to information by a SIP terminal in the VoIP network system. FIG. 7 depicts a flowchart of the method for subscribing to information by a SIP terminal in the VoIP network system according to an embodiment of the invention.

As shown in FIG. 7, firstly, at step 705, a SIP terminal such as the SIP terminal 101 creates a subscribing request with the subscribing conditions embedded in.

In the present embodiment, the SIP SUBSCRIBE/NOTIFY method is used to accomplish the subscribing functionality. That is, the present embodiment allows the SIP terminal to subscribe to information by using the SIP SUBSCRIBE message and get the newest information from the SIP information center 104 by the SIP NOTIFY message.

Therefore, creating a subscribing request at step 705 is to create a SIP SUBSCRIBE message with the subscribing conditions embedded in the message body. For example, the subscribing condition may be that the SIP terminal wishes to get weather forecast or real estate information from the SIP information center 104 everyday.

Next, at step 710, the SIP terminal sends the subscribing request to the SIP application server 103.

At step 715, the SIP application server 103 recognizes the subscribing request and records the subscribing event.

At step 720, the SIP application server 103 monitors the update events of the SIP information center 104 according to the subscribing request to determine whether there is newest information of the topic subscribed by the subscribing request.

In the preferred embodiment, the SIP information center 104 will notify its update events to the SIP application server 103 when there is new information published in the SIP information center 104 by a SIP customer.

In an alternative embodiment, the SIP information center 104 will notify its update events to the SIP application server 103 periodically, for example everyday.

At step 725, when it is determined that there is newest information of the topic in the SIP information center 104, the SIP application server 103 gets the newest information from the SIP information center 104 and creates a notifying message with the newest information of the topic embedded in.

In the present embodiment, as described above, the SIP SUBSCRIBE/NOTIFY method is used to accomplish the subscribing functionality. That is, in the present embodiment, the SIP application server 103 uses the SIP NOTIFY message to send the newest information from the SIP information center 104 to the SIP terminal.

Therefore, creating a notifying message at step 725 is to create a SIP NOTIFY message with the content subscribed by the SIP terminal embedded in the message body.

Next, at step 730, the SIP application server 103 returns the notifying message with the newest information embedded in to the SIP terminal.

The above is a description of the method for subscribing to information by a SIP terminal in the VoIP network system according to an embodiment of the invention. It can be seen from the above description that with the method according to the embodiment, the SIP customers can easily subscribe to his/her interested topic or information from the SIP information center provided by service provider via SIP phones.

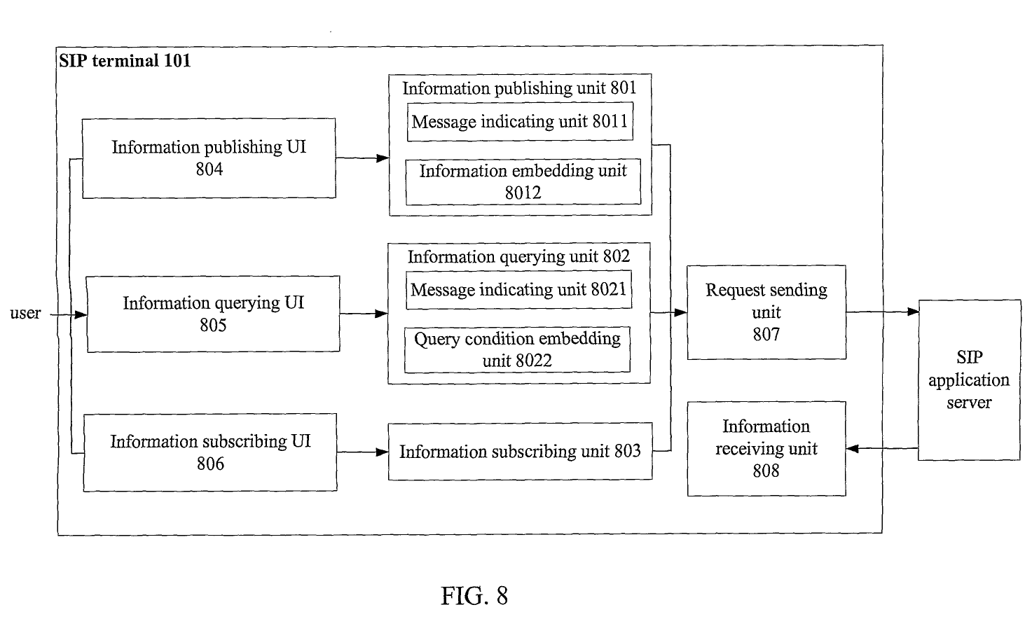

Under the same inventive conception, FIG. 8 depicts a schematic block diagram of the SIP terminal according to an embodiment of the invention, which is implemented in the VoIP network system 100 of FIG. 1 as the SIP terminal 101.

As shown in FIG. 8, the SIP terminal 101 comprises at least one of the following: information publishing unit 801 configured to create a publishing request with information to be published embedded in information querying unit 802 configured to create a querying request with query conditions embedded in; and information subscribing unit 803 configured to create a subscribing request with subscribing conditions for subscribing to user-interested topic embedded in.

More specifically, the information publishing unit 801 creates a publishing request in the form of FIG. 3 (b). That is, in the embodiment, the publishing request created by the information publishing unit 801 is extended from the SIP REGISTER message.

As shown in FIG. 8, the information publishing unit 801 can further comprise: message indicating unit 8011 configured to indicate the SIP REGISTER message as a publishing request; and information embedding unit 8012 configured to embed the information to be published in the body of the SIP REGISTER message.

More specifically, the message indicating unit 8011 sets the content type field of the SIP REGISTER message as “application/publish+xml” to indicate that this is a publishing request. The information embedding unit 8012 embeds the information to be published in the part <publish> of the body of the SIP REGISTER message in a pre-defined publish pattern, such as that of FIG. 3 (a), to obtain the publishing request.

The information querying unit 802 creates a querying request in the form of FIG. 5 (b). That is, in the embodiment, the querying request created by the information querying unit 802 also is extended from the SIP REGISTER message.

As shown in FIG. 8, the information querying unit 802 can further comprise: message indicating unit 8021 configured to indicate the SIP REGISTER message as a querying request; and query condition embedding unit 8022 configured to embed the query conditions in the body of the SIP REGISTER message.

More specifically, the message indicating unit 8021 sets the content type field of the SIP REGISTER message as “application/query+xml” to indicate that this is a querying request. The query condition embedding unit 8022 embeds the query conditions in the part <query> of the body of the SIP REGISTER message in a pre-defined query pattern, such as that of FIG. 5 (a), to obtain the querying request.

The information subscribing unit 803 creates a SIP SUBSCRIBE message and embeds the subscribing conditions in the message body to obtain the subscribing request.

In addition, the SIP terminal 101 can further comprise at least one of the following: information publishing UT 804 through which user can input the information to be published; information querying UI 805 through which user can input the query conditions; and information subscribing UI 806 through which user can input the subscribing conditions.

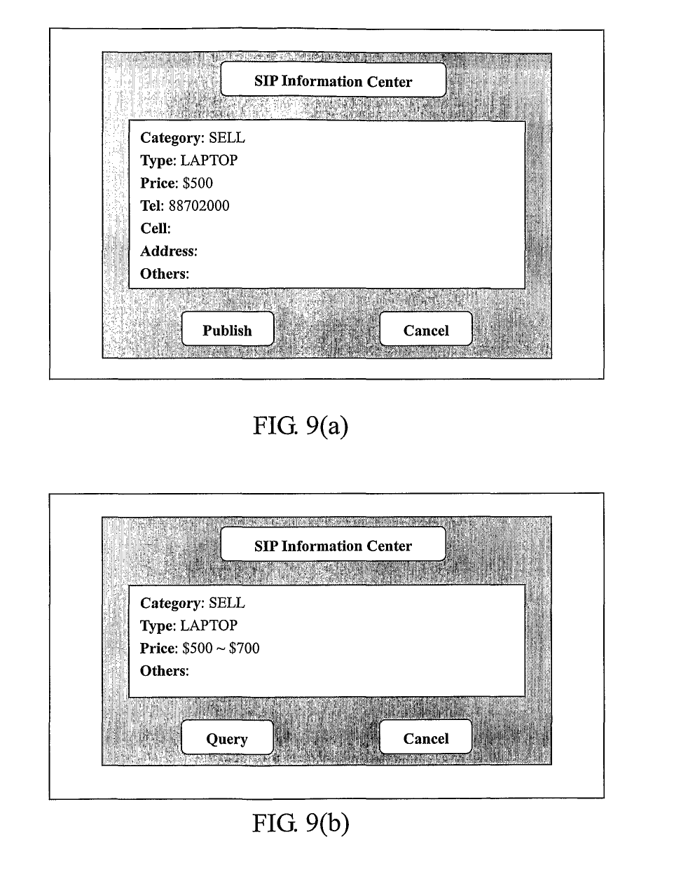

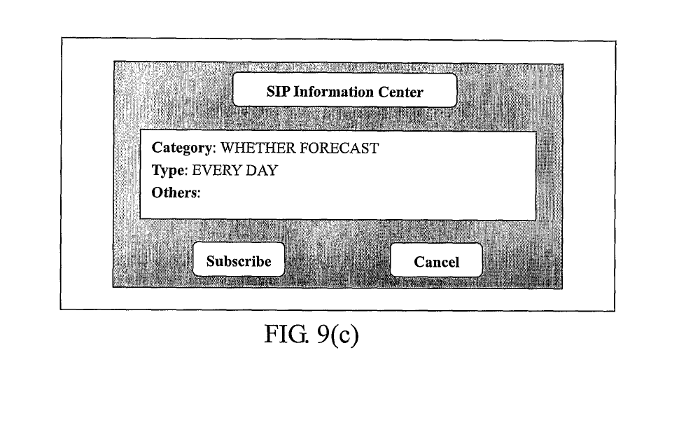

FIG. 9(a) depicts an exemplary information publishing UI 804 for user to input information to be published on the SIP terminal 101 according to an embodiment of the invention, which is in the publish pattern of FIG. 3(a); FIG. 9(b) depicts an exemplary information querying UI 805 for user to input query conditions on the SIP terminal 101 according to an embodiment of the invention, which is in the query pattern of FIG. 5(a); and FIG. 9(c) depicts an exemplary information subscribing UI 806 for user to input subscribing conditions on the SIP terminal 101 according to an embodiment of the invention.

In addition, the SIP terminal 101 can further comprise: request sending unit 807 configured to send the publishing request created by the information publishing unit 801, the querying request created by the information querying unit 802 or the subscribing request created by the information subscribing unit 803 to the SIP information center, such as the SIP information center 104, via the SIP application server, such as the SIP application server 103; and information receiving unit 808 configured to receive information from the SIP information center, such as the SIP information center 104, via the SIP application server, such as the SIP application server 103.

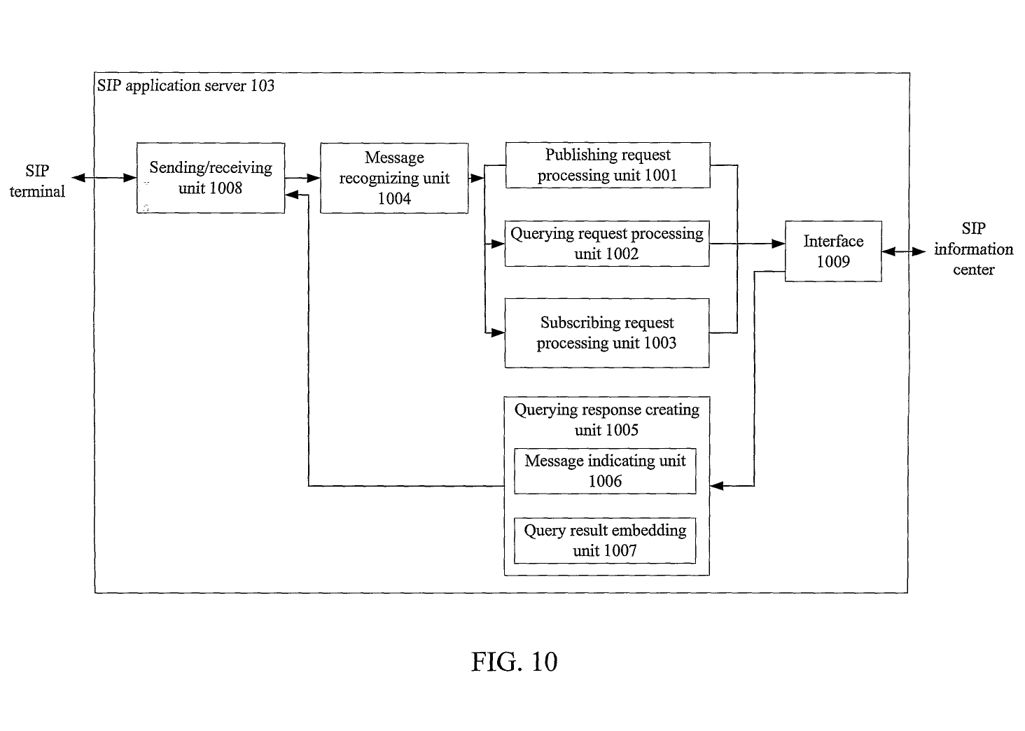

Under the same inventive conception, FIG. 10 depicts a schematic block diagram of the SIP application server according to an embodiment of the invention, which is implemented in the VoIP network system 100 of FIG. 1 as the SIP application server 103.

As shown in FIG. 10, the SIP application server 103 comprises at least one of the following: publishing request processing unit 1001 configured to obtain information to be published from a publishing request received from a SIP terminal and forward it to SIP information center interacting with the SIP application server; querying request processing unit 1002 configured to obtain query conditions from a querying request received from a SIP terminal and forward them to the SIP information center; and subscribing request processing unit 1003 configured to monitor the update of the SIP information center and notify the new information in the SIP information center, which is subscribed by a subscribing request received from a SIP terminal, to the SIP terminal.

In addition, the SIP application server 103 can further comprise: message recognizing unit 1004 configured to recognize the publishing request, the querying request and the subscribing request from received messages and distribute them respectively to the publishing request processing unit 1001, the querying request processing unit 1002 and the subscribing request processing unit 1003.

More specifically, the message recognizing unit 1004 recognizes the received message. If it is a SIP REGISTER message and the value of the content type field therein is “application/publish+xml”, then the message recognizing unit 1004 recognizes the message as a publishing request and distributes it to the publishing request processing unit 1001. The publishing request processing unit 1001 obtains the information to be published from the SIP REGISTER message and forwards it to the SIP information center, such as the SIP information center 104.

If the message is a SIP REGISTER message and the value of the content type field therein is “application/query+xml”, then the message recognizing unit 1004 recognizes it as a querying request and distributes it to the querying request processing unit 1002. The querying request processing unit 1002 obtains the query conditions from the SIP REGISTER message and forwards them to the SIP information center, such as the SIP information center 104.

In addition, if the message is a SIP SUBSCRIBE message, then the message recognizing unit 1004 recognizes it as a subscribing request and distributes it to the subscribing request processing unit 1003. The subscribing request processing unit 1003 records the subscribing event and monitors the update events notified from the SIP information center to determine whether there is newest information of the topic subscribed by the subscribing event. If there is newest information of the topic in the SIP information center, the subscribing request processing unit 1003 gets the information from the SIP information center and notifies it to the SIP terminal.

In addition, the SIP application server 103 can further comprise: querying response creating unit 1005 configured to create a querying response message with the query results received from the SIP information center embedded in.

More specifically, the querying response creating unit 1005 creates a querying response message in the form of FIG. 6. That is, in the embodiment, the querying response message created by the querying response creating unit 1005 is extended from the SIP 200 OK response message.

As shown in FIG. 10, the querying response creating unit 1005 can further comprise: message indicating unit 1006 configured to indicate the SIP 200 OK response message as a querying response message; and query result embedding unit 1007 configured to embed the query results in the body of the SIP 200 OK response message.

More specifically, the message indicating unit 1006 sets the content type field of the SIP 200 OK response message as “application/query+xml” to indicate that this is a querying response message. The query result embedding unit 1007 embeds the query results, which are received from the SIP information center, in the part <query> of the body of the SIP 200 OK response message in a pre-defined pattern to obtain the querying response message.

In addition, the SIP application server 103 can further comprise: sending/receiving unit 1008 configured to receive requests from/send responses to a SIP terminal, such as the SIP terminal 101; and interface 1009 through which the SIP application server 103 exchanges information with the SIP information center, such as the SIP information center 104.

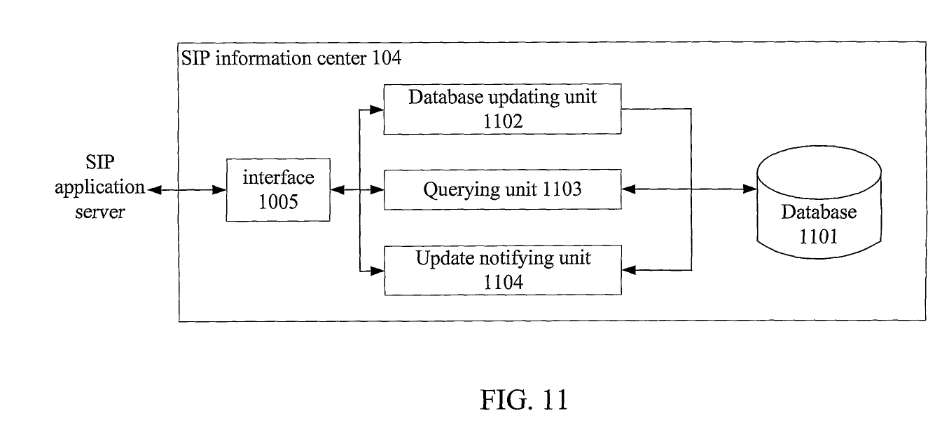

Under the same inventive conception, FIG. 11 depicts a schematic block diagram of the SIP information center in the VoIP network system of FIG. 1 according to an embodiment of the invention, which is implemented in the VoIP network system 100 of FIG. 1 as the SIP information center 104.

As shown in FIG. 11, the SIP information center 104 comprises: at least one database 1101 for storing information; database updating unit 1102 configured to update the at least one database 1101 based on information to be published which is received from a SIP terminal, such as the SIP terminal 101, via a SIP application server, such as the SIP application server 103; and querying unit 1103 configured to query the at least one database for the information meeting query conditions received from a SIP terminal, such as the SIP terminal 101, via the SIP application server.

In addition, the SIP information center 104 can further comprise: update notifying unit 1104 configured to notify update events of the at least one database 1101 to the SIP application server 103.

In the preferred embodiment, the update notifying unit 1104 will notify the update events of the at least one database 1101 of the SIP information center 104 to the SIP application server 103 when there is new information published in the at least one database 1101 by SIP customer.

In an alternative embodiment, the update notifying unit 1104 will notify the update events of the at least one database 1101 to the SIP application server 103 periodically, for example everyday.

In addition, the SIP information center 104 can further comprise: interface 1105 through which the SIP information center 104 exchanges information with the SIP application server 103.

It can be appreciated that the SIP terminal 101, the SIP application server 103 and the SIP information center 104, and their components can be implemented with specifically designed circuits or chips or be implemented by a computing device (information processing device) executing corresponding programs. Moreover, the respective components of the SIP terminal 101, the SIP application server 103 and the SIP information center 104 may be physically separated but operationally cooperated.

The above is a description of the preferred embodiments of the invention. It can be seen from the above description that the invention can give user great convenience and also create profit to service provider by allowing the SIP customers to publish, query, subscribe to information to/from the SIP information center.

While the methods respectively for publishing, querying and subscribing to information by a SIP terminal in a VoIP network system, SIP terminal, SIP application server, SIP information center and VoIP network system of the present invention have been described in detail with some exemplary embodiments, these embodiments are not exhaustive, and those skilled in the art may make various variations and modifications within the spirit and scope of the present invention. Therefore, the present invention is not limited to these embodiments, the scope of which is only defined by appended claims.

1. A method for publishing information by a SIP terminal in a VoIP network system, wherein the VoIP network system is deployed with SIP information center for storing and providing at least the information; said method comprises:
creating a publishing request with the information to be published embedded in at the SIP terminal;
sending the publishing request from the SIP terminal to the SIP information center via the SIP application server; and
recording the information in the SIP information center's database.

2. The method for publishing information by a SIP terminal in a VoIP network system according to claim 1, wherein the publishing request is in a form of a SIP REGISTER message, and said step of creating comprises:
indicating the SIP REGISTER message as a publishing request; and
embedding the information to be published in the body of the SIP REGISTER message.

3. The method for publishing information by a SIP terminal in a VoIP network system according to claim 2, wherein said step of indicating the SIP REGISTER message as a publishing request comprises:
indicating the SIP REGISTER message as a publishing request with a content type field contained in the message.

4. The method for publishing information by a SIP terminal in a VoIP network system according to claim 2, wherein said step of sending comprises:
sending the SIP REGISTER message from the SIP terminal to the SIP application server;
recognizing the SIP REGISTER message as a publishing request at the SIP application server;
obtaining the information to be published from the body of the SIP REGISTER message at the SIP application server; and
forwarding the information to be published from the SIP application server to the SIP information center.

5. The method for publishing information by a SIP terminal in a VoIP network system according to claim 1, wherein said step of recording comprises:
receiving the obtained information to be published from the SIP application server at the SIP information center; and
updating the SIP information center's database to contain the information.

6. A method for querying information by a SIP terminal in a VoIP network system, wherein the VoIP network system is deployed with a SIP information center for storing and providing at least the information; said method comprises:
creating a querying request with query conditions embedded in at the SIP terminal;
sending the querying request from the SIP terminal to the SIP information center via the SIP application server;
querying the information according to the querying request at the SIP information center; and
returning query results from the SIP information center to the SIP terminal via the SIP application server.

7. The method for querying information by a SIP terminal in a VoIP network system according to claim 6, wherein the querying request is in a form of a SIP REGISTER message, and said step of creating comprises:
indicating the SIP REGISTER message as a querying request; and
embedding the query conditions in the body of the SIP REGISTER message.

8. The method for querying information by a SIP terminal in a VoIP network system according to claim 7, wherein said step of indicating the SIP REGISTER message as a querying request comprises:
indicating the SIP REGISTER message as a querying request with a content type field contained in the message.

9. The method for querying information by a SIP terminal in a VoIP network system according to claim 7, wherein said step of sending comprises:
sending the SIP REGISTER message from the SIP terminal to the SIP application server;
recognizing the SIP REGISTER message as a querying request at the SIP application server;
obtaining the query conditions from the body of the SIP REGISTER message at the SIP application server; and
forwarding the query conditions from the SIP application server to the SIP information center.

10. The method for querying information by a SIP terminal in a VoIP network system according to claim 9, said step of querying comprises:
receiving the query conditions from the SIP application server at the SIP information center; and
querying information which meets the query conditions from the SIP information center's database.

11. The method for querying information by a SIP terminal in a VoIP network system according to claim 6, said step of returning further comprising:
sending back query results from the SIP information center to the SIP application server; and
returning the query results from the SIP application server to the SIP terminal by a querying response message.

12. The method for querying information by a SIP terminal in a VoIP network system according to claim 11, wherein the querying response message is in a form of a SIP 200 OK response message, and said step of returning the query results from the SIP application server to the SIP terminal by a querying response message further comprising:
indicating the SIP 200 OK response message as a querying response message;
embedding the query results in the body of the SIP 200 OK response message; and
sending the SIP 200 OK response message from the SIP application server to the SIP terminal.

13. The method for querying information by a SIP terminal in a VoIP network system according to claim 12, wherein the step of indicating the SIP 200 OK response message as a querying response message comprises:
indicating the SIP 200 OK response message as a querying response message with a content type field contained in the message.

14. A method for subscribing to information by a SIP terminal in a VoIP network system, wherein the VoIP network system is deployed with a SIP information center for storing and providing at least the information; said method comprises:
creating a subscribing request with subscribing conditions for subscribing to user-interested topic embedded in at the SIP terminal;
sending the subscribing request from the SIP terminal to the SIP application server;
monitoring whether there is new information published in the SIP information center which meets the subscribing conditions; and
when there is new information of this topic published in the SIP information center, notifying it from the SIP information center to the SIP terminal via the SIP application server.

15. A SIP terminal, comprising at least one of the following:
an information publishing unit configured to create a publishing request with information to be published embedded in;
an information querying unit configured to create a querying request with query conditions embedded in; and
an information subscribing unit configured to create a subscribing request with subscribing conditions for subscribing to user-interested topic embedded in.

16. The SIP terminal according to claim 15, wherein the publishing request is in a form of a SIP REGISTER message, and the information publishing unit further comprises:
a message indicating unit configured to indicate the SIP REGISTER message as a publishing request; and
an information embedding unit configured to embed the information to be published in the body of the SIP REGISTER message.

17. The SIP terminal according to claim 15, wherein the querying request is in a form of a SIP REGISTER message, and the information querying unit further comprises:
a message indicating unit configured to indicate the SIP REGISTER message as a querying request; and
a query condition embedding unit configured to embed the query conditions in the body of the SIP REGISTER message.

18. The SIP terminal according to claim 15, further comprising at least one of the following:
an information publishing UI through which user can input the information to be published;
an information querying UI through which user can input the query conditions; and
an information subscribing UI through which user can input the subscribing conditions.

19. A SIP application server, comprising at least one of the following:
a publishing request processing unit configured to obtain information to be published from a publishing request received from a SIP terminal and forward it to SIP information center interacting with the SIP application server;
a querying request processing unit configured to obtain query conditions from a querying request received from a SIP terminal and forward them to the SIP information center; and
a subscribing request processing unit configured to monitor the update of the SIP information center and notify the new information in the SIP information center, which is subscribed by a subscribing request received from a SIP terminal, to the SIP terminal.

20. The SIP application server according to claim 19, further comprising:
a message recognizing unit configured to recognize the publishing request, the querying request and the subscribing request from received messages and distribute them respectively to the publishing request processing unit, the querying request processing unit and the subscribing request processing unit.

21. The SIP application server according to claim 19, further comprising:
a querying response creating unit configured to create a querying response message with the query results received from the SIP information center embedded in.

22. The SIP application server according to claim 21, wherein the querying response message is in a form of a SIP 200 OK response message, and the querying response creating unit further comprises:
a message indicating unit configured to indicate the SIP 200 OK response message as a querying response message; and
a query result embedding unit configured to embed the query results received from the SIP information center in the body of the SIP 200 OK response message.

23. A SIP information center, comprising:
at least one database for storing information;
a database updating unit configured to update the at least one database based on information to be published which is received from a SIP terminal via a SIP application server; and
a querying unit configured to query the at least one database for the information meeting query conditions received from a SIP terminal via a SIP application server.

24. The SIP information center according to claim 23, further comprising:
an update notifying unit configured to notify update events of the at least one database to the SIP application server.

25. The SIP terminal according to claim 15 implemented in a network system comprising
at least one SIP application server and
at least one SIP information center.
